(19) United States
(12) Patent Application Publication
(10) Pub. No.: US 2018/0275688 A1
(43) Pub. Date: Sep. 27, 2018

(54) FUEL DISPENSER WITH FLOW RATE COMPENSATION

(71) Applicant: Gilbarco Inc., Greensboro, NC (US)

(72) Inventor: Christopher Adam Oldham, High Point, NC (US)

(21) Appl. No.: 15/470,139

(22) Filed: Mar. 27, 2017

(51) Int. Cl. G05D 7/06; B67D 7/04; B67D 7/14; B67D 7/16; B67D 7/36

(52) U.S. Cl. CPC G05D 7/0623; B67D 7/04; B67D 7/36; B67D 7/16; B67D 7/14

(57) ABSTRACT

A fuel dispenser comprises a fuel nozzle configured to be connected to a vehicle fuel system and fuel piping configured to transfer fuel from at least one fuel storage tank associated with the fuel dispenser through the fuel nozzle into the vehicle fuel system. A flow control valve is located along the fuel piping. A fuel dispenser controller comprises processing circuitry configured to receive vehicle fuel system data from a vehicle, determine a desired flow rate based on the vehicle fuel system data, and control the flow control valve to prevent a fuel flow rate from exceeding the desired flow rate.

### BACKGROUND

The present invention relates generally to equipment used in fuel dispensing environments. More specifically, embodiments of the present invention relate to a fuel dispenser with flow rate compensation.

Typical fuel dispensers dispense fuel at a rate controlled by a manually-operated valve on the nozzle. The maximum flow rate allowed by the dispenser's internal control valve is set by regulation and does not account for differences in the ability of a particular vehicle to accept the fuel. Factors such as fill neck configuration, level of fuel in the tank, and status of the vehicle's evaporative emission control system (EVAP) may allow a lesser or greater flow rate than the regulatory maximum. Nozzle snapoff (i.e., an automatic shutting of the nozzle valve in response to sensing fuel in the fill neck of the fuel tank) and vapor release can occur at higher flow rates.

### SUMMARY

The present invention recognizes and addresses various considerations of prior art constructions and methods. According to one aspect, the present invention provides a fuel dispenser controller including processing circuitry configured to receive vehicle fuel system data from a vehicle, determine a desired flow rate (such as a maximum efficient flow rate) based on the vehicle fuel system data, and control a flow control valve to prevent dispensing of fuel at a rate exceeding the desired flow rate.

In another example embodiment, a fuel dispenser is provided including a fuel nozzle configured to be connected to a vehicle fuel system, fuel piping configured to transfer fuel from at least one fuel storage tank associated with the fuel dispenser through the fuel nozzle into the vehicle fuel system, and a fuel dispenser controller comprising processing circuitry. The processing circuitry is configured to receive vehicle fuel system data from a vehicle, determine a desired flow rate based on the vehicle fuel system data, and control a flow control valve to prevent dispensing of fuel at a rate exceeding the desired flow rate.

Those skilled in the art will appreciate the scope of the present invention and realize additional aspects thereof after reading the following detailed description of preferred embodiments in association with the accompanying drawing figures.

### BRIEF DESCRIPTION OF THE DRAWINGS

A full and enabling disclosure of the present invention, including the best mode thereof directed to one skilled in the art, is set forth in the specification, which makes reference to the appended drawings, in which:

FIG. 1 illustrates a perspective view of an exemplary fuel dispenser in accordance with an embodiment of the present invention.

FIG. 2 illustrates a diagrammatic representation of internal components of the fuel dispenser of FIG. 1 according to an embodiment of the present invention.

FIG. 3 illustrates an example vehicle and fuel dispenser including wireless communication antennas according to an embodiment of the present invention.

FIGS. 4A and 4B illustrate example fuel dispenser nozzles and vehicle fuel filling ports according to embodiments of the present invention.

FIG. 5 illustrates a block diagram of a vehicle diagnostic system in communication with a controller of the fuel dispenser according to an example embodiment of the present invention.

FIG. 6 illustrates a block diagram of one example of processing circuitry according to an embodiment of the present invention.

FIG. 7 illustrates a method of utilizing a flow control valve according to an example embodiment of the present invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the present disclosure including the appended claims and their equivalents.

A fuel dispenser controller may be provided which is configured to determine a desired flow rate (e.g., a maximum efficient flow rate) for fuel based on vehicle fuel system data. The controller may control a flow control valve to prevent a flow rate of the fuel being dispensed from exceeding the desired flow rate. The term “maximum efficient flow rate” as used herein may define a flow rate which limits or prevents nozzle snap-off or fuel vapor release to atmosphere.

The desired flow rate may be based on vehicle fuel system data received from the vehicle through wired or wireless communication with a vehicle diagnostic or control system associated with a vehicle being fueled. The vehicle fuel system data may include a current fuel tank level, an EVAP performance parameter, vehicle type (or other indicator of fuel tank configuration), or the like.

Additionally or alternatively, the vehicle fuel system data may be received by reading (e.g., scanning) a code associated with the fuel system, such as within a fuel port. In some instances, a fuel nozzle of the fuel dispenser may include a code reader to ascertain a code disposed in or near the fuel port of the vehicle. The code may be a QR code, bar code, alphanumerical code, or the like and be indicative of a fuel tank configuration of the vehicle.

### Example Fuel Dispenser

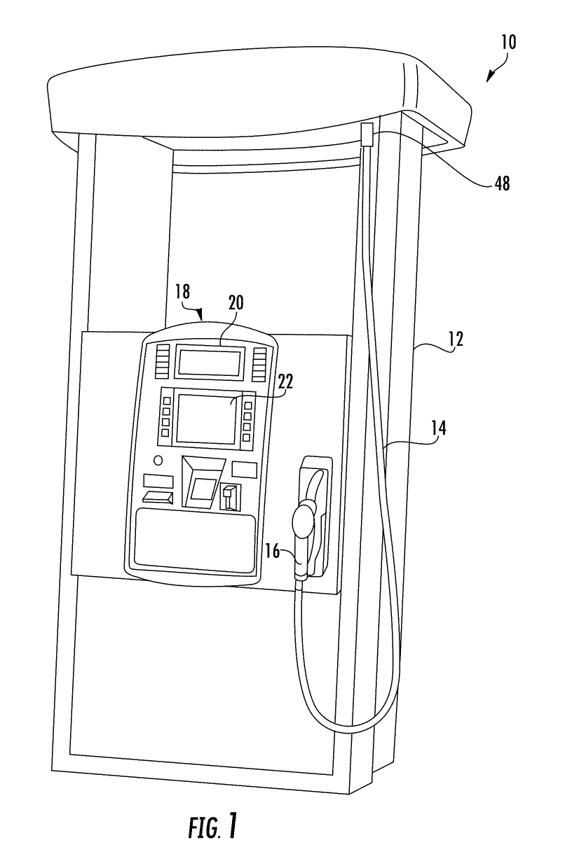

FIG. 1 is a perspective view of an exemplary fuel dispenser 10 according to an embodiment of the present invention. Fuel dispenser 10 includes a housing 12 with a flexible fuel hose 14 extending therefrom. Fuel hose 14 terminates in a fuel nozzle 16 adapted to be inserted into a fill neck of a vehicle's fuel tank. Fuel nozzle 16 includes a manually-operated fuel valve. Various fuel handling components, such as valves and meters, are also located inside of housing 12. These fuel handling components allow fuel to be received from underground piping and delivered through fuel hose 14 and fuel nozzle 16 to a vehicle's fuel system, e.g. fuel tank.

Fuel dispenser 10 has a customer interface 18. Customer interface 18 may include an information display 20 relating to an ongoing fueling transaction that includes the amount of fuel dispensed and the price of the dispensed fuel. Further, customer interface 18 may include a display 22 that provides instructions to the customer regarding the fueling transaction. Display 22 may also provide advertising, merchandising, and multimedia presentations to a customer, and may allow the customer to purchase goods and services other than fuel at the dispenser.

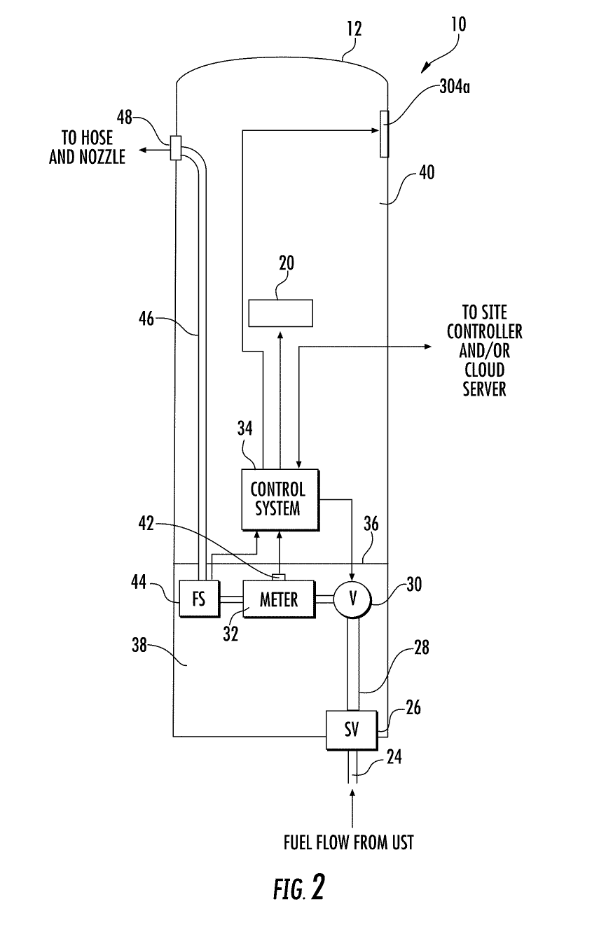

FIG. 2 is a schematic illustration of internal fuel flow components of fuel dispenser 10 according to an embodiment of the present invention. In general, fuel may travel from an underground storage tank (UST) via main fuel piping 24, which may be a double-walled pipe having secondary containment as is well known, to fuel dispenser 10 and nozzle 16 for delivery. An exemplary underground fuel delivery system is illustrated in U.S. Pat. No. 6,435,204, hereby incorporated by reference in its entirety for all purposes. More specifically, a submersible turbine pump (STP) associated with the UST is used to pump fuel to the fuel dispenser 10. However, some fuel dispensers may be self-contained, meaning fuel is drawn to the fuel dispenser 10 by a pump unit positioned within housing 12.

Main fuel piping 24 passes into housing 12 through a shear valve 26. As is well known, shear valve 26 is designed to close the fuel flow path in the event of an impact to fuel dispenser 10. U.S. Pat. No. 8,291,928, hereby incorporated by reference in its entirety for all purposes, discloses an exemplary secondarily-contained shear valve adapted for use in service station environments. Shear valve 26 contains an internal fuel flow path to carry fuel from main fuel piping 24 to internal fuel piping 28.

Fuel from the shear valve 26 flows toward a flow control valve 30 positioned upstream of a flow meter 32. Alternatively, flow control valve 30 may be positioned downstream of the flow meter 32. In one embodiment, flow control valve 30 may be a proportional solenoid controlled valve, such as described in U.S. Pat. No. 5,954,080, hereby incorporated by reference in its entirety for all purposes.

Flow control valve 30 is under control of a control system 34. In this manner, control system 34 can control the opening and closing of flow control valve 30 to either allow fuel to flow or not flow through meter 32 and on to the hose 14 and nozzle 16. Control system 34 may comprise any suitable electronics with associated memory and software programs running thereon whether referred to as a processor, microprocessor, controller, microcontroller, or the like. In a preferred embodiment, control system 34 may be comparable to the microprocessor-based control systems used in CRIND (card reader in dispenser) type units sold by Gilbarco Inc. Control system 34 typically controls other aspects of fuel dispenser 10, such as valves, displays, and the like. For example, control system 34 typically instructs flow control valve 30 to open when a fueling transaction is authorized. In addition, control system 34 may be in electronic communication with a point-of sale system (POS), which may include a site controller, located at the fueling site. The site controller communicates with control system 34 to control authorization of fueling transactions and other conventional activities. Control system 34 may also communicate directly or indirectly with one of more remote servers (e.g., in the “cloud”).

A vapor barrier 36 delimits hydraulics compartment 38 of fuel dispenser 10, and control system 34 is located in electronics compartment 40 above vapor barrier 36. Fluid handling components, such as flow meter 32, are located in hydraulics compartment 38. In this regard, flow meter 32 may be any suitable flow meter known to those of skill in the art, including positive displacement, inferential, and Coriolis mass flow meters, among others. Meter 32 typically comprises electronics 42 that communicates information representative of the flow rate or volume to control system 34. For example, electronics 42 may typically include a pulser as known to those skilled in the art. In this manner, control system 34 can update the total gallons (or liters) dispensed and the price of the fuel dispensed on information display 20.

As fuel leaves flow meter 32 it enters a flow switch 44, which preferably comprises a one-way check valve that prevents rearward flow through fuel dispenser 10. Flow switch 44 provides a flow switch communication signal to control system 34 when fuel is flowing through flow meter 32. The flow switch communication signal indicates to control system 34 that fuel is actually flowing in the fuel delivery path and that subsequent signals from flow meter 32 are due to actual fuel flow. Fuel from flow switch 44 exits through internal fuel piping 46 to fuel hose 14 and nozzle 16 for delivery to the customer's vehicle.

In an example embodiment, a breakaway device 48 may connect the internal piping 46 to the hose 14. The breakaway device 48 will typically have a separable portion configured to detach from the dispenser 10 and/or internal piping 46 in response to a force applied to the breakaway device 48 exceeding a predetermined threshold, for example 100 lbs, or the like. Suitable breakaways are disclosed in U.S. Pat. Nos. 7,487,796 and 6,899,131, each of which is incorporated by reference herein in its entirety for all purposes.

A blend manifold may also be provided downstream of flow switch 44. The blend manifold receives fuels of varying octane levels from the various USTs and ensures that fuel of the octane level selected by the customer is delivered. In addition, fuel dispenser 10 may in some embodiments comprise a vapor recovery system to recover fuel vapors through nozzle 16 and hose 14 to return to the UST. An example of a vapor recovery assist equipped fuel dispenser is disclosed in U.S. Pat. No. 5,040,577, incorporated by reference herein in its entirety for all purposes.

### Example Fuel Flow Compensation

As noted above, embodiments of the present invention provide flow rate compensation by the dispenser via receipt of vehicle fuel system data from the vehicle. Modern vehicles have well-documented interfaces to allow the vehicle to monitor sensors and detect problems, adjust timing that can be triggering an engine warning, or create a warning event that an owner may not be aware of. Such a system is referred to as the OBD-II (on-board diagnostics II) system in cars, or J1587 or J1939 in trucks or heavier vehicles (depending on type). In this regard, dispenser 10 is preferably equipped with a suitable wired or wireless interface to facilitate communication with the vehicle's diagnostic system.

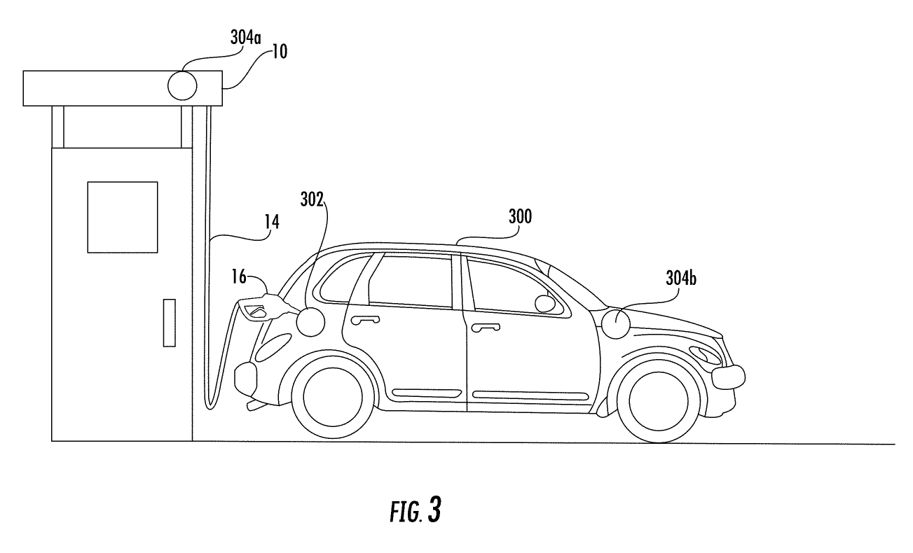

In this regard, FIG. 3 illustrates fuel dispenser 10 in communication with a vehicle 300 into which fuel is being dispensed. As shown, the communication is in this case wireless via antennas 304a and 304b (collectively 304) on the dispenser 10 and vehicle 300, respectively. In particular, antennas 304 may be configured to communicate vehicle data including vehicle fuel system data from the vehicle 300 to the fuel dispenser 10. The wireless communication antennas 304 may be configured for any suitable communication protocol such as Bluetooth, Zigbee, WiFi, V2X (IEEE 802.11p), or the like.

Toward this end, the controller 34 of the fuel dispenser 10 may be configured to cause the associated wireless communication antenna 304a to transmit a data request when a transaction is authorized and/or when vehicle 300 is detected in a fueling area associated with the fuel dispenser 10 (such as due to motion sensor activation, a weight sensor activation, or the like). Thereafter, further fuel system data may be transmitted to dispenser 10 during the fueling event, such as at predetermined intervals (e.g., every 1 second) or when necessary or desired by changes in the fueling conditions.

In response to the data request, the vehicle 300 may cause the associated wireless communication antenna 304b to transmit vehicle fuel system data to the fuel dispenser 10. The vehicle fuel system data may be indicative of a fuel tank configuration (such as the length and shape of the vehicle's fill neck), a predetermined maximum flow rate for the vehicle, or the like. In some example embodiments, the vehicle fuel system data may include data indicative of one or more vehicle parameters, such as vehicle operating conditions sensed by a vehicle diagnostic system. These vehicle operating conditions may include, for example, a current level (volume) of fuel in the tank, an EVAP performance parameter, or the like.

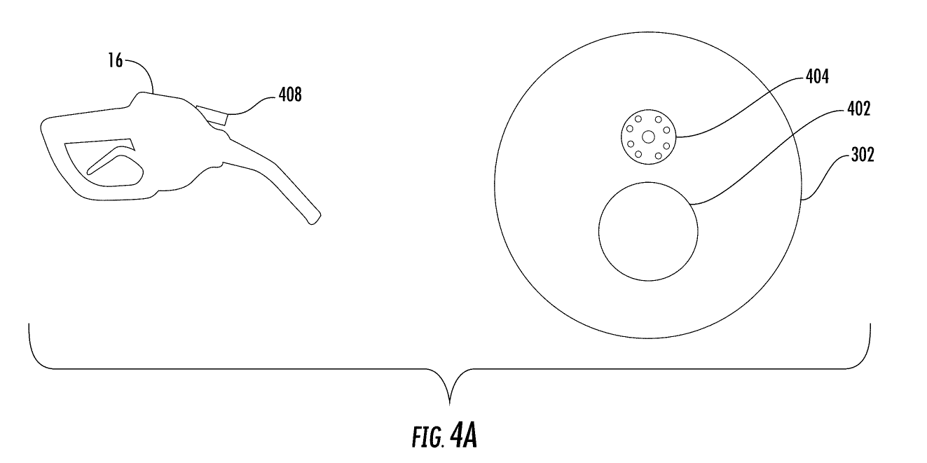

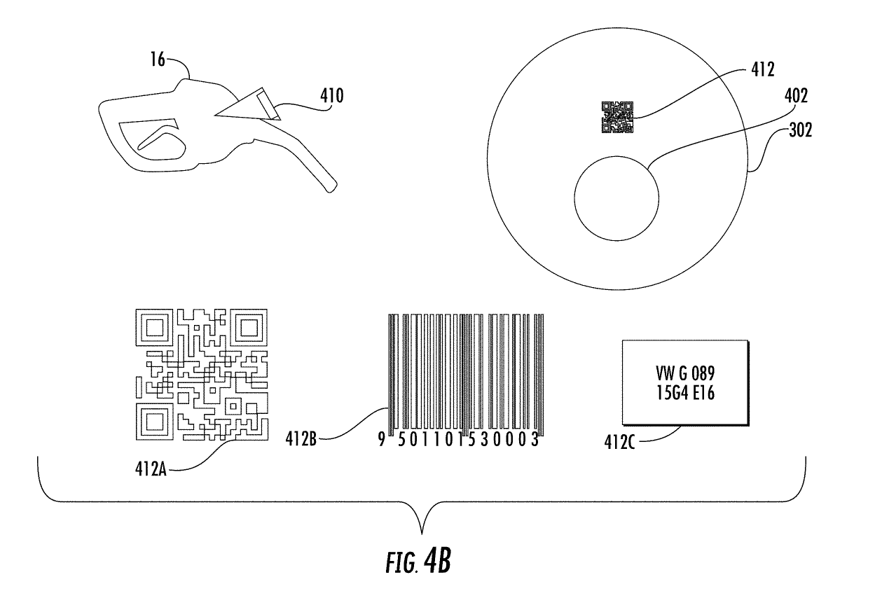

Additionally or alternatively, the controller 34 may receive the vehicle fuel system data through wired communication with the vehicle 300, as shown in the example embodiment depicted in FIG. 4A. For example, the fuel nozzle 16 may include a data connector 408, which may be operably coupled to a vehicle data port 404, during fueling. In some example embodiments, the vehicle data port 404 may be disposed on the vehicle in or near a fuel port 302 (e.g., the area behind the fuel fill door). In an example embodiment, the vehicle data port 404 is disposed above an aperture 402 for the fuel tank fill neck. The data connector 408 may be disposed above a spout of the fuel nozzle 16, such that the data connector 408 couples with the vehicle data port 404 when the spout portion of the fuel nozzle 16 is inserted into the aperture 402. The data connection between the data connector 408 and the vehicle data port 404 may provide an analog signal connection, digital signal connection, optical signal connection, or the like. Wires may be disposed along the fuel hose 14 to facilitate data communication between the data connector 408 and the controller 34 of dispenser 10.

The controller 34 may determine a maximum efficient flow rate based on the vehicle fuel system data received through the wired or wireless communication interface. In an example embodiment, the fuel system data may include any information that can be used to adjust the flow rate on a vehicle-by-vehicle basis. For example, the vehicle can directly provide information about its fuel tank configuration or merely provide information identifying the make and model of the vehicle (from which the fuel tank configuration can be determined). The fuel tank configuration may include a total volume of the fuel tank, a shape of the fuel tank, a fuel tank vent size, a fuel fill neck size and/or shape, or any other information which may be used to determine a maximum rate at which the specific fuel tank may be filled without causing or limiting nozzle snapoff or excessive fuel vapor release. In addition, as noted above, operational information from the vehicle, such as current fuel tank level and EVAP performance parameters, can be provided before and/or during fueling to adjust dynamically the desired flow rate.

Referring now to FIG. 4B, the fuel nozzle 16 in some example embodiments may include or be associated a suitable code reader device, such as an optical reader 410. Optical reader 410 may read indicia (e.g., code 412) located adjacent the fill neck of the vehicle's fuel system which indicates the vehicle type or other information from which characteristics of the vehicle's fueling system can be determined. For example, the indicia may take the form of a QR code 412A, bar code 412B, alphanumerical code 412C, or the like. While this embodiment may not allow the maximum flow to be dynamically changed based on information during the fueling event, some customization of dispensing parameters can be achieved based on the prior knowledge of the vehicle's fuel tank configuration. The code 412 may contain enough information to define fully the fuel tank configuration. More typically, however, code 412 will either indicate the maximum flow rate or will contain information indicating the vehicle type (i.e., make and model).

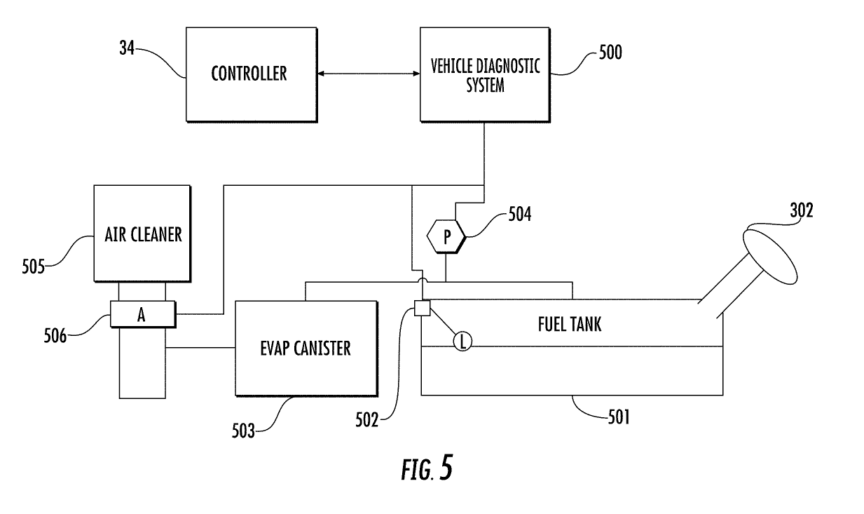

FIG. 5 illustrates a block diagram of a vehicle diagnostic system 500 in communication with a controller 34 of the fuel dispenser 10 according to an example embodiment. The controller 34 may be in wired or wireless data communication with the vehicle diagnostic system 500, such as described above in FIGS. 3 and 4A. The vehicle diagnostic system 500 may itself be in data communication with one or more sensors on the vehicle, such as a fuel level sensor 502 (e.g., a float sensor, ultrasonic sensor, or the like), a pressure sensor 504 (e.g., piezoresistive strain gauge, electromagnetic sensor, capacitive sensor, or the like), and/or an air flow sensor 506 (e.g., venturi, turbine, or the like), or the like. The sensors may provide vehicle parameter data to the vehicle diagnostic system, such as the current level or pressure of the fuel tank 501, one or more EVAP parameters, or the like. EVAP parameters may include an air flow rate through an EVAP canister 503 and/or an air cleaner 505, a pressure associated with the EVAP, or the like.

The controller 34 may receive the vehicle fuel system data including the vehicle parameter data from the vehicle diagnostic system 500 and use that information at least in part to determine a maximum efficient flow rate. In an example embodiment, the maximum efficient flow rate may be determined once per fueling operation, such as based on the shape, size, and venting capabilities associated with the fuel tank 501. In some example embodiments, the maximum efficient flow rate may be determined at predetermined intervals (such as every 1 seconds) in response to a predetermined number of vehicle fuel system data reports, or the like. In an example embodiment, the maximum efficient flow rate may be determined dynamically for each instance that the vehicle fuel system data is received.

In an example embodiment in which the maximum efficient flow rate is determined at a predetermined interval or dynamically, the controller 34 may vary the maximum efficient flow rate based on the current fuel tank level. For example, the controller 34 may reduce the flow rate in response to a current fuel tank level approaching a full level and increase the maximum efficient flow rate in response to an indication of the current fuel tank level near an empty fuel level. In some example embodiments, the controller 34 may vary the maximum efficient flow rate based on the pressure associated with the fuel tank 501; for example the controller 34 may reduce the flow rate in response to an indication of a high fuel tank pressure. (A higher pressure may be indicative of the flow rate into the fuel tank 501 exceeding the venting capability of the fuel tank 501.) The controller may increase the maximum efficient flow rate in response to an indication of a low pressure, e.g. a pressure less than a predetermined pressure threshold. In an example embodiment, the controller 34 may vary the maximum efficient flow rate based on one or more EVAP parameters. For example the controller 34 may reduce the maximum efficient flow rate in response to an indication of a high air flow or pressure through the EVAP, which may be indicative of excessive fuel vapor venting through the EVAP to atmosphere. As one skilled in the art will appreciate, these parameters indicating various operating conditions will typically serve as adjustments to the nominal maximum efficient flow rate determined from the fuel tank configuration data.

The controller 34 may control a flow control valve, such as flow control valve 30 or another flow control valve disposed in the internal piping 46, to prevent the flow rate from exceeding the maximum efficient flow rate. In particular, the flow control valve 30 may be positioned such that the maximum achievable flow rate with the manually-operated valve of the fuel nozzle 16 fully open may be less than, or equal to, the maximum efficient flow rate. The controller 34 may reposition the flow control valve based on interval based or dynamic determinations of the maximum efficient flow rate. Dynamic or interval based maximum efficient fuel rate determinations may allow for a higher flow rate initially and a slower flow rate as the fuel tank 501 reaches the full level. This may desirably minimize the time needed to fill the tank so as to enhance customer satisfaction and increase transaction throughput at the station, while limiting vapor emissions and overfill.

### Example Processing Circuitry

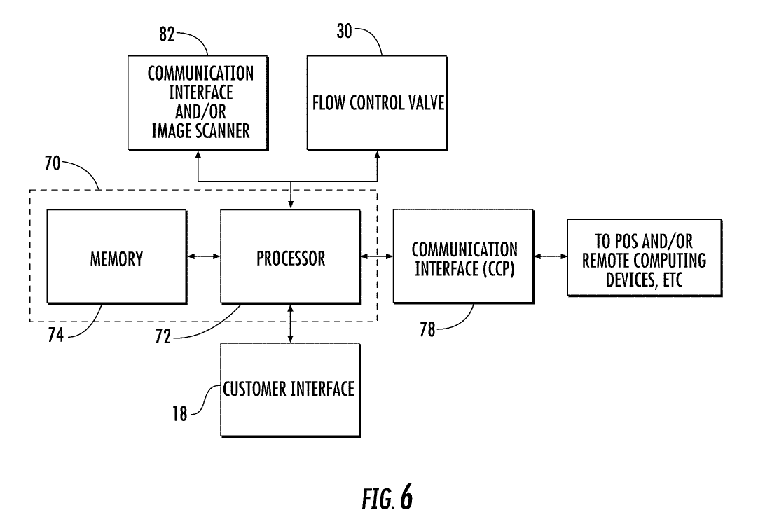

FIG. 6 shows certain elements of processing circuitry 70 according to an example embodiment. The processing circuitry 70 of FIG. 6 may be employed, for example, on onboard circuitry within the control system 34, a convenience store, a network device, server, proxy, or the like. Alternatively, embodiments may be employed on a combination of devices. Furthermore, it should be noted that the devices or elements described below may not be mandatory and thus some may be omitted in certain embodiments.

In an example embodiment, processing circuitry 70 is configured to perform data processing, application execution and other processing and management services according to an example embodiment of the present invention. In one embodiment, the processing circuitry 70 may include a processor 72 and a memory 74. Processor 72 may be in communication with or otherwise control a customer interface 18 and/or communication interface 78. As such, the processing circuitry 70 may be embodied as a circuit chip (e.g., an integrated circuit chip) configured (e.g., with hardware, software or a combination of hardware and software) to perform operations described herein. However, in some embodiments, the processing circuitry 70 may be embodied as a portion of a server, computer, or workstation. The network may be a data network, such as a local area network (LAN), a metropolitan area network (MAN), a wide area network (WAN) (e.g., the Internet), and/or the like, which may couple the processing circuitry 70, the control system 34, and/or the fuel dispenser 10 to devices such as processing elements (e.g., computer terminals, server computers or the like) and/or databases. Communication between the network, the processing circuitry 70, the control system 34, and the devices or databases (e.g., servers) to which the processing circuitry 70 is coupled may be accomplished by either wired or wireless communication mechanisms and corresponding communication protocols. Wired communication may include electronic communication, optical communication, or any other wired data communication.

The customer interface 18 may be an input/output device for receiving instructions directly from a user. The consumer interface 18 may include, for example, a keyboard, a mouse, a joystick, a display (e.g., a touch screen display), a microphone, a speaker, or other input/output mechanisms. Further, the processing circuitry 70 may comprise, or be in communication with, user interface circuitry configured to control at least some functions of one or more elements of the consumer interface 18. The processing circuitry 70 may be configured to control one or more functions of one or more elements of the customer interface 18 through computer program instructions (e.g., software and/or firmware) stored on a memory device accessible to the processing circuitry 70 (e.g., volatile memory, non-volatile memory, and/or the like). In some example embodiments, the circuitry of customer interface 18 is configured to facilitate user control of at least some functions of the apparatus through the use of a display configured to respond to user inputs. The processing circuitry 70 may also comprise, or be in communication with, display circuitry configured to display at least a portion of the customer interface 18, the display and the display circuitry configured to facilitate user control of at least some functions of the fuel dispenser.

The communication interface 78 may be any means such as a device or circuitry embodied in either hardware, software, or a combination of hardware and software that is configured to receive and/or transmit data from/to a network and/or any other device or module in communication with the control system 34 and/or the POS of the fueling environment (and/or a remote cloud server, either directly or via a router located in the convenience store). In some instances the communications interface 78 may be referred to as a cloud connection processor (CCP) and may provide secured, e.g., encrypted, communication between the processing circuitry 70, the network, and/or remote servers or remote computing devices. The communication interface 78 may also include, for example, an antenna (or multiple antennas) and supporting hardware and/or software for enabling communications with the network or other devices (e.g., a user device). In some environments, the communication interface 78 may alternatively or additionally support wired communication. As such, for example, the communication interface 78 may include a communication modem and/or other hardware/software for supporting communication via cable, digital subscriber line (DSL), universal serial bus (USB) or wireless other mechanisms.

The processing circuitry 70 may also include or otherwise be in communication with a valve actuator of the flow control valve 30. The valve actuator may include a magnetic coil and plunger, a servo motor, or other device to control the position of the flow control valve 30. The processing circuitry 70 may control the position of the flow control valve 30 to prevent a fuel flow rate from exceeding the maximum efficient flow rate.

The processing circuitry 70 may include or otherwise be in communication with a communication interface for receiving data from the vehicle and/or a code reader (collectively and individually 82). As noted above, the communication interface may be wired or wireless. The code reader may be optical reader (e.g., a QR code reader, a barcode reader, an alphanumeric reader, or the like) as described above.

### Example Flowchart(s) and Operations

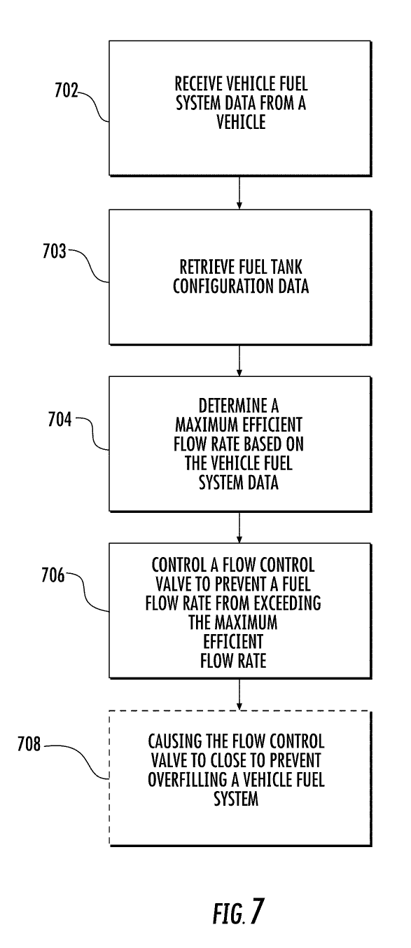

Embodiments of the present invention provide methods, apparatus and computer program products for flow rate compensation based on vehicle fuel system data. Various examples of the operations performed in accordance with embodiments of the present invention will now be provided with reference to FIG. 7.

The operations illustrated in and described with respect to FIG. 7 may, for example, be performed by, with the assistance of, and/or under the control of one or more of the processor 72, memory 74, communication interface 78, flow control valve 30, a wired or wireless communication interface between the dispenser and the vehicle, and/or a code reader. The method depicted in FIG. 7 may include receiving vehicle fuel system data from a vehicle at operation 702, retrieving vehicle fuel tank configuration data at operation 703, determining a maximum efficient flow rate based on the vehicle fuel system data at operation 704, and causing a flow control valve to prevent a fuel flow rate from exceeding the maximum efficient flow rate at operation 706.

In some embodiments, the method may include additional, optional operations, and/or the operations described above may be modified or augmented. For example, as indicated by dashed lines, the flow control valve may be caused to close to prevent overfilling a vehicle fuel system at operation 708.

FIG. 7 illustrates a flowchart of a system, method, and computer program product according to an example embodiment. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 74 and executed by, for example, the processor 72. As will be appreciated, any such computer program product may be loaded onto a computer or other programmable apparatus (for example, the processing circuitry of the fuel flow control valve) to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device to cause a series of operations to be performed on the computer or other programmable apparatus to produce a computer-implemented process such that the instructions which execute on the computer or other programmable apparatus implement the functions specified in the flowchart block(s).

In some embodiments, the dispenser may be further configured for additional operations or optional modifications. In this regard, in an example embodiment, the maximum efficient flow rate comprises a flow rate which limits nozzle snap-off or fuel vapor release to atmosphere. In an example embodiment, the vehicle fuel system data is indicative of a fuel tank configuration. In some example embodiments, the processing circuitry receives the vehicle fuel system data from a code reader associated a fuel dispenser. In an example embodiment, the fuel system data includes a barcode, QR code, or an alphanumeric code. In some example embodiments, the vehicle fuel system data includes a current fuel tank level and the determination of the maximum efficient flow rate is based on the current fuel tank level. In an example embodiment, the vehicle fuel system data comprises an evaporative emission control system (EVAP) performance parameter and the determination of the maximum efficient flow rate is based on the EVAP performance parameter. In some example embodiments, the processing circuitry receives the vehicle fuel system data from a vehicle diagnostic system associated with the vehicle. In an example embodiment, the vehicle fuel system data is received wirelessly from the vehicle diagnostic system. In some example embodiments, the processing circuitry receives the vehicle fuel system data from the vehicle diagnostic system through a wired data connection with the vehicle.

Many modifications and other embodiments of the systems and/or methodology set forth herein will come to mind to one skilled in the art to which they pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A fuel dispenser comprising:
a fuel nozzle configured to be connected to a vehicle fuel system;
fuel piping configured to transfer fuel from at least one fuel storage tank associated with the fuel dispenser through the fuel nozzle into the vehicle fuel system; and
a flow control valve located along the fuel piping;
a fuel dispenser controller comprising processing circuitry configured to:
receive vehicle fuel system data from a vehicle;
determine a desired flow rate based on the vehicle fuel system data; and
control the flow control valve to prevent a fuel flow rate from exceeding the desired flow rate.

2. The fuel dispenser of claim 1, wherein the desired flow rate comprises a flow rate which prevents nozzle snap-off or fuel vapor release to atmosphere.

3. The fuel dispenser of claim 1, wherein the vehicle fuel system data is indicative of a fuel tank configuration.

4. The fuel dispenser of claim 1 further comprising a code reader device, wherein the processing circuitry receives at least some of the vehicle fuel system data from the code reader device.

5. The fuel dispenser of claim 4, wherein the code reader device comprises an optical scanner and the fuel system data comprises at least one of a barcode, QR code, and an alphanumeric code.

6. The fuel dispenser of claim 1, wherein the vehicle fuel system data comprises a current fuel tank level, and
wherein the determination of the desired flow rate is based on the current fuel tank level.

7. The fuel dispenser of claim 1, wherein the vehicle fuel system data comprises an evaporative emission control system (EVAP) performance parameter, and
wherein the determination of the maximum efficient flow rate is based on the EVAP performance parameter.

8. The fuel dispenser of claim 1, wherein the processing circuitry receives the vehicle fuel system data from a vehicle diagnostic system associated with the vehicle.

9. The fuel dispenser of claim 8, wherein the vehicle fuel system data is received wirelessly from the vehicle diagnostic system.

10. The fuel dispenser of claim 8, wherein the processing circuitry receives the vehicle fuel system data from the vehicle diagnostic system through a wired data interface with the vehicle.

11. A fuel dispenser controller comprising processing circuitry configured to:
receive vehicle fuel system data from a vehicle to be fueled;
determine a desired flow rate based on the vehicle fuel system data; and
control a flow control valve to prevent a fuel flow rate from exceeding the desired flow rate.

12. The fuel dispenser controller of claim 11, wherein the desired flow rate comprises a flow rate which limits nozzle snap-off or fuel vapor release to atmosphere.

13. The fuel dispenser controller of claim 11, wherein the vehicle fuel system data is indicative of a fuel tank configuration.

14. The fuel dispenser controller of claim 11, wherein the processing circuitry receives the vehicle fuel system data from a code reader device associated a fuel dispenser.

15. The fuel dispenser controller of claim 14, wherein the code reader device comprises an optical scanner and the fuel system data comprises at least one of a barcode, QR code, and an alphanumeric code.

16. The fuel dispenser controller of claim 11, wherein the vehicle fuel system data comprises a current fuel tank level, and
wherein the determination of the desired flow rate is based on the current fuel tank level.

17. The fuel dispenser controller of claim 11, wherein the vehicle fuel system data comprises an evaporative emission control system (EVAP) performance parameter, and
wherein the determination of the maximum efficient flow rate is based on the EVAP performance parameter.

18. The fuel dispenser controller of claim 11, wherein the processing circuitry receives the vehicle fuel system data from a vehicle diagnostic system associated with the vehicle.

19. The fuel dispenser controller of claim 18, wherein the vehicle fuel system data is received wirelessly from the vehicle diagnostic system.

20. The fuel dispenser controller of claim 18, wherein the processing circuitry receives the vehicle fuel system data from the vehicle diagnostic system through a wired data interface with the vehicle.
